(19) United States
(12) Patent Application Publication
(10) Pub. No.: US 2010/0106538 A1
(43) Pub. Date: Apr. 29, 2010

(54) DETERMINING DISASTER RECOVERY SERVICE LEVEL AGREEMENTS FOR DATA COMPONENTS OF AN APPLICATION

(75) Inventors: Ramani R. Routray, San Jose, CA (US); Upendra Sharma, Amherst, MA (US); Aameek Singh, University Place, WA (US); Sandeep M. Uttamchandani, San Jose, CA (US); Akshat Verma, New Delhi (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/256,799

(22) Filed: Oct. 23, 2008

(51) Int. Cl. G06Q 10/00; G06Q 50/00

(52) U.S. Cl. 705/7

(57) ABSTRACT

Techniques for determining one or more disaster recovery (DR) service level agreements (SLAs) for each of one or more components of an application are provided. The techniques include identifying one or more components of an application, capturing one or more intra-application data dependencies between the one or more components, and mapping each of the one or more components to a DR profile to determine one or more DR SLAs for each of the one or more components of an application.

### FIELD OF THE INVENTION

Embodiments of the invention generally relates to information technology, and, more particularly, to disaster recovery.

### BACKGROUND OF THE INVENTION

Disaster recovery (DR) planning, in many existing approaches, starts by getting requirements from the administrator (referred to as DR profiles). A common approach is to apply the profile to all of the data associated with the application, that is, the DR planner provides the same level of DR support to all of the application data. In reality, however, a requirement could arise to differentiate the data of the application for the purpose of DR planning (and system management in general). For example, if an application's data has data, log and index, the DR planner can treat the index differently from the data, which in turn can be treated differently from the data.

Unlike existing approaches, data classification (and hence differentiated DR service level agreements (SLAs) for each component of an application) should be an important criterion for DR planning because multiple vendors may have DR planners, and the key differentiator will be the ability to optimize resource utilization using application-specific and/or vertical-market libraries with white-box information about the application's operational and data details. In existing approaches, however, no tools exist in this domain, and some existing approaches disadvantageously use manual techniques that are hand-crafted and/or based on guesses.

### SUMMARY OF THE INVENTION

Principles of the invention provide techniques for determining disaster recovery (DR) service level agreements (SLAs) for data components of an application. An exemplary method (which may be computer-implemented) for determining one or more disaster recovery (DR) service level agreements (SLAs) for each of one or more components of an application, according to one aspect of the invention, can include steps of identifying one or more components of an application, capturing one or more intra-application data dependencies between the one or more components, and mapping each of the one or more components to a DR profile to determine one or more DR SLAs for each of the one or more components of an application.

One or more embodiments of the invention or elements thereof can be implemented in the form of a computer product/storage medium including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the embodiments of the invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating techniques for disaster recovery planning, according to an embodiment of the present invention;

FIG. 2 is a flow diagram illustrating techniques for disaster recovery planning, according to an embodiment of the present invention;

FIG. 3 is a flow diagram illustrating techniques for determining one or more disaster recovery (DR) service level agreements (SLAs) for each of one or more components of an application, according to an embodiment of the present invention; and

FIG. 4 is a system diagram of an exemplary computer system on which at least one embodiment of the present invention can be implemented.

### DETAILED DESCRIPTION OF PREFERRED EMBODIMENTS

Principles of the invention include an intra-application differentiated disaster recovery (DR) planning framework. Additionally, principles of the invention include automatically inferring the DR service level agreements (SLAs) for each component of an application from the DR SLAs of the application in a way such that the differentiated DR SLAs for each component lead to meeting the DR SLAs for the application. Further, in one or more embodiments of the invention, the differentiated DR SLAs present an optimal way to meet the application SLAs by taking the intra-application data dependencies and resource usage of individual components into account. Also, the techniques described herein detail how to represent the dependencies information and use it for DR planning. Also, in one or more embodiments of the invention, application specific data can be provided by vertical market segment consultants and/or experts.

One or more embodiments of the invention include performing intra-application DR based on the type of data, as well as identifying application data dependencies and performing differentiated DR planning. Additionally, unlike the disadvantageous existing approaches, the techniques described herein include differentiated DR planning that has the ability to capture intra-application data dependencies. Further, one or more embodiments of the present invention also include intelligent planning based on category of data, application dependence and sequencing of data sources.

Also, given a DR service level agreement (SLA) for an application, one may derive a set of SLAs for individual data sources. Data dependencies for the application are known and can be used to learn DR SLAs for data sources. As such, one or more embodiments of the invention include creating DR SLAs for data components recursively from DR SLA for the application. One can use application-to-data dependency relationships that capture serial dependency, subsumption, invariance and composition. One can also optimize SLA values based on data update rates and optimize overall cost by dividing the SLA parameter among component SLAs in the most cost-effective manner (for example, where the optimization uses gradient-based optimization). Additionally, one can use templates that capture application-to-data dependencies.

In one or more embodiments of the invention, an application-to-data mapper creates dependency relationships between data. Given a DR SLA for an application, a workflow can be created using the data sources. DR SLA values are assigned to each step in the workflow so that the application SLA is met.

As described herein, one or more embodiments of the invention can include the following intra-application dependencies and characteristics.
Temporal Dependence: A<B (B depends on A: Data B can be recovered only after data A is recovered);
Subsumption A [symbol] 5 B (A subsumes B: Data B can be reconstructed from data A in five minutes);
Invariant A [symbol] 30 (Invariant A: Data A does not change more often than once in 30 minutes);
Aggregation A=[B,C,D] (Data A includes data B, data C, data D: A is recovered once B, C and D are recovered);

Further, because an application is recovered by creating a recovery workflow for all of the data that constitutes the application, in one or more embodiments of the invention, the DR SLA for each component of the application may have some requirements, which can be captured by the following notation.
e→2 A (replicate A two minutes after event e has occurred).

By way of example, one or more embodiments of the invention can include the following.
A<B (In a database, tablespaces can be recovered only after log has been recovered and transactional integrity restored);
A [symbol] 5 B (Index data can be reconstructed from tablespaces);
A [symbol] 30 (configuration files are updated only at 8:30 A.M.);
A=[B,C,D] (Trade application includes tablespace data, log data and index data); and
e→2 A (replicate configuration files two minutes after they are updated).

Additionally, one or more embodiments of the invention can be formulated as a covering problem on a directed graph where the cover set includes nodes for applications and/or data that need to be recovered. By way of example, the root node can be the application, and edges can have a cost versus DR SLA parameter curve that represents various technologies possible for the data. One can also, for example, let recovery time objective (RTO) represent one of the DR SLAs.

For a given node, aggregation relationships can be used to identify the data and create child nodes. For example, for a DB application A with data storage in a volume V1, log stored in volume V2, and index stored in volume V3, one has the relationship A=[V1, V2, V3]. Similarly, i<j dependencies can captured by creating a special node j′ and adding edges from i to j′, and from j′ to j. If j′ already exists, then one can use the existing j′. The edge [i,j′] has the RTO/cost curve that is the same as j, whereas the edge [j′,j] is zero cost. Also, subsume relationships can be captured by adding another node from the parent to the child with a zero cost edge and a RTO value equal to the reconstruction time. Invariant relationships can be captured by adding another edge to the node with a recovery point objective (RPO) reduced to the invariant limit and an event rule added to the edge.

Additionally, in one or more embodiments of the invention, a RTO/cost for a path can be computed as sum of the RTO/cost of all edges in the path. RTO for a node V can be computed, for example, as the maximum RTO amongst all paths that start from V. Cost for a node V can be computed, for example, as the sum of the cost of all selected paths from that node. Further, edges can be introduced for all possible sequences of recovery.

In one or more embodiments of the invention, one can find an assignment of RTO values to all the nodes such that all of the nodes that are part of the application are covered, the total cost of the nodes is minimized, and the RTO values meet the application SLA. A minimum spanning tree (MST) can be created from the root to all of its dependent nodes, and gradient-based techniques can be used to select the cost-RTO points for the nodes based on which the MST is selected. One can start with minimum cost for all edges, and select the edge to increase cost that leads to highest decrease in overall RTO.

The techniques described herein can also include using templates to identify pre-cooked assignments, wherein the templates are parametric in nature.

As described herein, one or more embodiments of the invention include intra-application differentiated DR planning. Such DR planning can include, for example, the ability to capture the intra-application data dependencies, the ability to include content semantics in DR planning and the ability to map data dependencies on a user-specified application DR profile. Additionally, the techniques described herein include transparently supported differentiated DR for the application, as well as the ability to minimizing DR costs by integrating copy services with backup and point-in-time snapshots. Further, one or more embodiments of the invention include optimizing searches for solutions that integrates the search space of replication and backup options.

DR planning input can also be synchronized with data dictionaries of popular applications (for example, SAP, Peoplesoft), classification engines (for example, data classifiers), application dependency trackers, system/application registries (signifying the updates to the application executables, which would help determine periodicity of copy (that is, a replica of the data)), and vertical industry experts. By way of example, input to a DR planner can include a DR Plan for DB, wherein input from runstats in DB2, for example, would determine the read-only, read-write tablespace(s). This would lead to a differentiated DR plan.

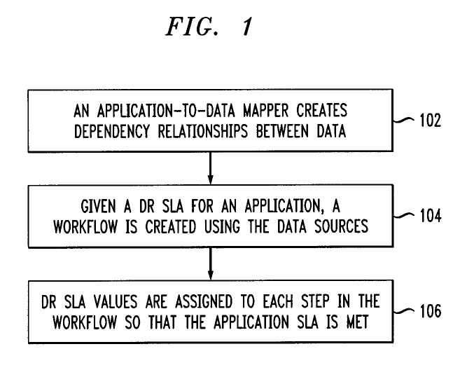

FIG. 1 is a flow diagram illustrating techniques for disaster recovery planning, according to an embodiment of the present invention. Step 102 includes using an application-to-data mapper to create dependency relationships between data. Step 104 includes, given a DR SLA for an application, creating a workflow using the data sources. Step 106 includes assigning DR SLA values to each step in the workflow so that the application SLA is met.

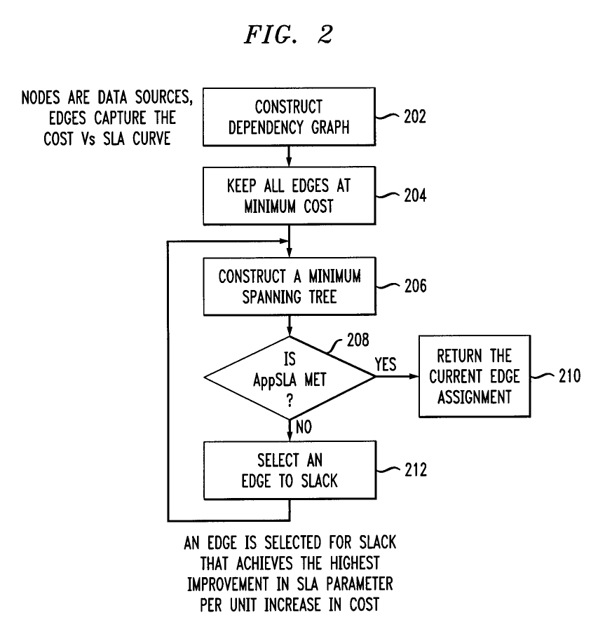

FIG. 2 is a flow diagram illustrating techniques for disaster recovery planning, according to an embodiment of the present invention. Step 202 includes constructing a dependency graph. Nodes can include data sources, and edges can capture the cost versus SLA curve. Step 204 includes keeping all edges at a minimum cost. Step 206 includes constructing a minimum spanning tree. Step 208 includes determining whether an application SLA (AppSLA) is met. If the answer is no, then one can select an edge to slack in step 212. An edge is selected for slack that achieves the highest improvement in SLA parameters per unit increase in cost. If the answer in step 208 is yes, the one can return the current edge assignment in step 210.

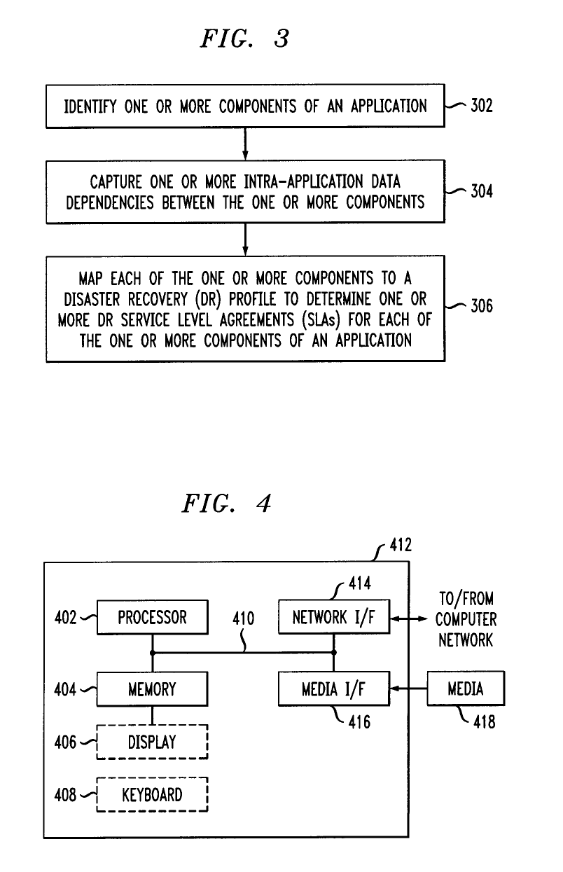

FIG. 3 is a flow diagram illustrating techniques for determining one or more disaster recovery (DR) service level agreements (SLAs) for each of one or more components of an application, according to an embodiment of the present invention. Step 302 includes identifying one or more components (for example, data components) of an application. Identifying data components can also include, for example, creating aggregation relationships.

Step 304 includes capturing one or more intra-application data dependencies between the one or more components. Capturing intra-application data dependencies can include obtaining application-specific data from vertical market segment consultants and/or experts.

Step 306 includes mapping each of the one or more components to a DR profile to determine one or more DR SLAs for each of the one or more components of an application (including, for example, deriving a set of SLAs for each of the components). Every component is attached a DR Profile such that if all DR profiles are met for the respective component, the DR profile of the application would be met. By way of example, assume that an application includes two components, data and index. Also assume that the RTO for the application is 10 minutes. Further, assume that index can only be recovered after data is recovered. As such, if a DR profile for data has an RTO of 5 minutes, then the DR profile for index should be less than (10−5=5), that is, 5 or less.

Mapping each of the components to a DR profile can include mapping each of the components to a DR profile (for example, a user-specified application DR profile) such that a recovery time objective (RTO) value is assigned to each of the components such that the components of the application are protected, a total cost of DR solutions is minimized, and the RTO values assigned to the components (in combination) meet the SLA of the application.

The techniques depicted in FIG. 3 can also include performing differentiated DR for the application by determining a DR solution for each component of the application independently such that the DR SLA of each component is met. Additionally, one or more embodiments of the invention include incorporating content semantics in DR planning as well as integrating copy services with backup and point-in-time snapshots. The techniques depicted in FIG. 3 can also include, for example, creating DR SLAs for data components recursively from a DR SLA for the application.

Further, one or more embodiments of the invention can include generating a directed graph, wherein a cover set of the graph includes nodes for applications and/or data that need to be recovered. One can capture dependencies between data sources by creating additional nodes and edges, wherein creating additional nodes and edges can include, for a given node, using aggregation relationships to identify data and create child nodes. For example, as detailed herein, for a DB application A with data storage in a volume V1, log stored in volume V2 and index stored in volume V3, one has the relationship A=[V1, V2, V3]. Also, i<j dependencies can captured by creating a special node j′ and adding edges from i to j′, and from j′ to j. If j′ already exists, then one can use the existing j′. The edge [i,j′] has the RTO/cost curve that is the same as j, whereas the edge [j′,j] is zero cost. Subsume relationships can be captured by adding another node from the parent to the child with a zero cost edge and a RTO value equal to the reconstruction time. Further, invariant relationships can be captured by adding another edge to the node with a recovery point objective (RPO) reduced to the invariant limit and an event rule added to the edge.

As described herein, a directed graph can include, for example, a root node that includes the application, and edges that include a cost versus DR SLA parameter curve that represents one or more technologies possible for the data. Also, one can perform an assignment of DR SLAs to each component on the directed graph by creating a minimum spanning tree (MST) from the root to each of its dependent nodes, and using gradient-based techniques to select cost-RTO points for the nodes based on which the MST is selected. By way of example, one can start with minimum cost for all edges and select the edge to increase cost that leads to highest decrease in overall RTO.

One or more embodiments of the invention can also include synchronizing DR planning input with data dictionaries of popular applications, classification engines, application dependency trackers, application registries and/or vertical industry experts.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that certain implementations will make substantial use of software running on a general-purpose computer or workstation. With reference to FIG. 4, such an implementation might employ, for example, a processor 402, a memory 404, and an input and/or output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 402, memory 404, and input and/or output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 418) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 404), magnetic tape, a removable computer diskette (for example, media 418), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 402 coupled directly or indirectly to memory elements 404 through a system bus 410. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, performing intra-application DR based on the type of data, as well as identifying application data dependencies and perform differentiated DR planning.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for determining one or more disaster recovery (DR) service level agreements (SLAs) for each of one or more components of an application, comprising the steps of:
identifying one or more components of an application;
capturing one or more intra-application data dependencies between the one or more components; and
mapping each of the one or more components to a DR profile to determine one or more DR SLAs for each of the one or more components of an application.

2. The method of claim 1, wherein mapping each of the one or more components to a DR profile comprises mapping each of the one or more components to a DR profile such that a recovery time objective (RTO) value is assigned to each of the one or more components such that the one or more components of the application are protected, a total cost of one or more DR solutions is minimized, and the RTO value assigned to each component, in combination, meet an SLA of the application.

3. The method of claim 1, wherein identifying one or more data components further comprises creating one or more aggregation relationships.

4. The method of claim 1, further comprising performing differentiated DR for the application by determining a DR solution for each component of the application independently such that the DR SLA of each component is met.

5. The method of claim 1, wherein the application DR profile comprises a user-specified application DR profile.

6. The method of claim 1, further comprising incorporating one or more content semantics in DR planning.

7. The method of claim 1, further comprising integrating one or more copy services with one or more backup and point-in-time snapshots.

8. The method of claim 1, wherein capturing one or more intra-application data dependencies comprises obtaining application-specific data from at least one of one or more vertical market segment consultants and one or more experts.

9. The method of claim 1, further comprising creating one or more DR SLAs for one or more data components recursively from a DR SLA for the application.

10. The method of claim 1, further comprising generating a directed graph, wherein a cover set of the graph comprises one or more nodes for at least one of one or more applications and data that need to be recovered.

11. The method of claim 10, further comprising capturing one or more dependencies between one or more data sources by creating one or more additional nodes and edges.

12. The method of claim 11, wherein creating one or more additional nodes and edges comprises for a given node, using aggregation relationships to identify data and create one or more child nodes.

13. The method of claim 10, wherein the directed graph comprises a root node comprising the application, and one or more edges comprising a cost versus DR SLA parameter curve that represents one or more technologies possible for the data.

14. The method of claim 13, further comprising performing an assignment of one or more DR SLAs to each component on the directed graph, wherein performing the assignment comprises:
creating a minimum spanning tree (MST) from the root to each of its one or more dependent nodes;
using one or more gradient-based techniques to select one or more cost-RTO points for the one or more nodes based on which the MST is selected.

15. The method of claim 1, further comprising synchronizing DR planning input with at least one of one or more data dictionaries of popular applications, one or more classification engines, one or more application dependency trackers, one or more application registries and one or more vertical industry experts.

16. A computer program product comprising a computer readable medium having computer readable program code for determining one or more disaster recovery (DR) service level agreements (SLAs) for each of one or more components of an application, said computer program product including:
computer readable program code for identifying one or more components of an application;
computer readable program code for capturing one or more intra-application data dependencies between the one or more components; and
computer readable program code for mapping each of the one or more components to a DR profile to determine one or more DR SLAs for each of the one or more components of an application.

17. The computer program product of claim 16, wherein the computer readable program code for mapping each of the one or more components to a DR profile comprises computer readable program code for mapping each of the one or more components to a DR profile such that a recovery time objective (RTO) value is assigned to each of the one or more components such that the one or more components of the application are protected, a total cost of one or more DR solutions is minimized, and the RTO value assigned to each component, in combination, meet an SLA of the application.

18. The computer program product of claim 16, further comprising computer readable program code for generating a directed graph, wherein a cover set of the graph comprises one or more nodes for at least one of one or more applications and data that need to be recovered.

19. A system for determining one or more disaster recovery (DR) service level agreements (SLAs) for each of one or more components of an application, comprising:
a memory; and
at least one processor coupled to said memory and operative to:
identify one or more components of an application;
capture one or more intra-application data dependencies between the one or more components; and
map each of the one or more components to a DR profile to determine one or more DR SLAs for each of the one or more components of an application.

20. The system of claim 19, wherein in mapping each of the one or more components to a DR profile the at least one processor coupled to said memory is further operative to map each of the one or more components to a DR profile such that a recovery time objective (RTO) value is assigned to each of the one or more components such that the one or more components of the application are protected, a total cost of one or more DR solutions is minimized, and the RTO value assigned to each component, in combination, meet an SLA of the application.
